(19) United States
(12) Patent Application Publication
(10) Pub. No.: US 2004/0140415 A1
(43) Pub. Date: Jul. 22, 2004

(54) Vibration-attenuation devices having low lateral stiffness, and apparatus comprising same

(75) Inventor: Douglas C. Watson, Campbell, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 10/349,421

(22) Filed: Jan. 21, 2003

(51) Int. Cl. F16M 13/00

(52) U.S. Cl. 248/560

(57) ABSTRACT

Devices are disclosed for attenuating vibration transmission between a first mass and a second mass. An embodiment includes a housing defining a chamber configured to be pressurized with a fluid, at least one first pivot element coupled to the housing and the first mass, and at least one second pivot element coupled to the housing and the second mass. Lateral motion of the second mass relative to the first mass results in movement of the housing. Each of the pivot elements can be a diaphragm.

### FIELD

This disclosure pertains generally to the attenuation of vibrations and other movements from one physical body to another.

### BACKGROUND

The general problem of preventing the transmission of vibration and other movements from one body to another dates back to the dawn of the machine age. The development of increasingly complex machines has resulted in the ubiquitous utilization in such machines of any of various approaches to solving this problem. Increases in the accuracy of tasks performed by various machines have demanded increasingly sophisticated or more tailored approaches to reducing transmission of vibrations and the like from one portion of the machine to another and/or to a workpiece upon which a machine is performing a task. Also, addressing the general problem of arresting transmission of vibrations and other movements from an external source to a machine has become more important.

An example of a machine technology in which demands on accuracy and precision are extreme is microlithography as used, for example, in the manufacture of microelectronic devices (e.g., integrated circuits). Microlithography involves the transfer of a pattern, used to define a layer of a microelectronic device, onto a sensitized surface of a suitable substrate such as a semiconductor wafer. Hence, microlithography is analogous to an extremely sophisticated photographic printing process. Modern microlithography systems (commonly called “steppers”) are capable of imprinting patterns in which the pattern elements, as imaged on the substrate, have linewidths at or about the wavelength of light used to form the image. For example, certain modern steppers can form images of linear pattern elements having a linewidth of 0.25 or 0.18 μm, or even smaller, on the substrate. Achieving such a high level of performance requires that all imaging, positioning, and measuring systems of the stepper operate at their absolute limits of performance. This also requires that vibrations and other unwanted physical displacements be eliminated from the machine.

A conventional approach to vibration attenuation between two physical bodies involves the use of one or more air springs between the bodies. An air spring is a spring device in which the energy-storage element is air that is confined in a container that includes an elastomeric bellows or diaphragm. Air springs are commercially available in many different configurations and sizes and are used in a wide variety of applications with good success.

A key attribute of an air spring is its reduced stiffness with respect to the load applied to the air spring. (Usually the load is applied axially relative to the air spring.) For many applications (e.g., trucks and other heavy machinery), especially in situations in which attenuation of axial motion is the objective, an air spring is sufficient for achieving satisfactory vibration attenuation.

A disadvantage of an air spring for certain applications is its relatively high lateral stiffness. The high lateral stiffness can result in significant transmission via the air spring of non-axial motions from one body to another. If the subject machine is one (e.g., a stepper) in which and/or from which substantially all vibrations must be isolated completely, an air spring will exhibit unsatisfactory performance. For example, in a stepper machine any significant lateral stiffness in a vibration-attenuation device can cause problems with overlay accuracy of different layers as imaged on a wafer. Another possible problem is an increased moving standard deviation (“MSD”) between the reticle stage and the wafer stage.

Increasing the axial length of certain types of air springs can reduce their lateral stiffness. However, making an air spring longer may render certain uses of it impossible. This problem has arisen in modern stepper machines in which, despite the large size of a stepper machine, spaces between components and assemblies of the machine are usually very tight. For example, in most stepper machines the height of the focal plane of the projection lens above the floor of the room containing the machine is dictated by the height of adjacent robotics for transporting wafers to and from the machine. The dictated height usually is about 600 mm above the floor (which is a standard elevation in the industry). This 600-mm space must accommodate the massive wafer stage and its movement mechanisms, as well as various large support members for the stage, projection lens, and other portions of the machine. Under such conditions, the remaining available space simply is inadequate for accommodating air springs sized for achieving satisfactory performance.

Hence, in modem stepper machines and related types of equipment, there is a need for vibration attenuators that exhibit good vibration attenuation in the axial direction and that exhibit low lateral stiffness to prevent transmission of any vibrations between any of various portions of the machine.

### SUMMARY

Vibration-attenuation devices are described herein that exhibit low lateral stiffness. The vibration-attenuation devices are especially useful for placement along a support axis between a first mass and a second mass, and serve to attenuate transmission of motion from one of the masses to the other of the masses.

One disclosed embodiment of a device for placement between a first mass and a second mass includes a housing defining a chamber configured to be pressurized with a fluid. At least one first pivot element is coupled to the housing and the first mass and is situated in a first rotation plane. At least one second pivot element is coupled to the housing and the second mass and is situated in a second rotation plane. Lateral motion of the second mass relative to the first mass results in movement of the housing at the first rotation plane and the second rotation plane relative to the first and second masses, respectively. The pivot elements each can be, for example, a compliant member such as a flexible diaphragm or bellows. Alternatively, the pivot elements could be a rotatable mechanical fastener. The pivot elements typically are arranged in an inverted pendulum relationship with respect to each other as described in more detail below.

A variant of such a device can further include a first piston positioned adjacent to the first mass and a second piston positioned adjacent to the second mass. In such a variant the first pivot element is coupled to the housing and the first piston, and the second pivot element is coupled to the housing and the second piston.

A further disclosed embodiment of a device for placement between a first mass and a second mass includes a housing defining a unitary housing wall and a chamber configured to be pressurized with a fluid. At least one first flexible diaphragm is coupled to the first mass and the unitary housing wall and at least one second flexible diaphragm is coupled to the second mass and the unitary housing wall.

One particular embodiment of such a vibration-attenuation device includes a housing defining a first chamber configured to be pressurized with a fluid. A first mounting plate and a second mounting plate are coupled, respectively, to the first mass and the second mass. A first central mounting member is disposed between the first mounting plate and a first head-mounting ring. Similarly, a second central mounting member is disposed between the second mounting plate and a second head-mounting ring. A first diaphragm is coupled to the first mounting plate and the housing. A second diaphragm is coupled to the first central mounting member and the housing. A third diaphragm is coupled to the first head-mounting ring and the housing. A fourth diaphragm is coupled to the second mounting plate and the housing. A fifth diaphragm is coupled to the second central mounting member and the housing. A sixth diaphragm is coupled to the second head-mounting ring and the housing.

A system for attenuating vibrations between a first mass and a second mass is also described that includes a combination of at least one of the above-described devices and another vibration-attenuation device coupled to the first mass and the second mass. The other vibration-attenuation device comprises a housing coupled to the second mass, a cylinder received within the housing, a mounting element coupled to the first mass, a first diaphragm coupled to the housing and the cylinder, and a second diaphragm coupled to the mounting element and the cylinder.

A lithographic exposure apparatus that includes any of the above-described devices or systems is also disclosed.

The foregoing features will become more apparent from the following detailed description of several embodiments that proceeds with reference to the accompanying figures.

### BRIEF DESCRIPTION OF THE DRAWINGS

Certain embodiments are described below with reference to the following figures:

FIG. 1 is an elevational section of a vibration-attenuation device according to a first representative embodiment;

FIG. 2 is an elevational section of a vibration-attenuation device according to a second representative embodiment;

FIG. 3 is an elevational section of a vibration-attenuation system according to a third representative embodiment;

FIG. 4 is a schematic elevational view of a lithographic exposure apparatus according to a described embodiment;

FIG. 5 is a schematic elevational view of another embodiment of a lithographic exposure apparatus;

FIG. 6 is a block diagram of certain steps in a microelectronic-device fabrication process according to a described embodiment;

FIG. 7 is a block diagram of details of step 604 in FIG. 6;

FIG. 8 is an elevational section of a vibration-attenuation device according to a fourth representative embodiment;

FIG. 9 is an elevational section of a vibration-attenuation device according to a fifth representative embodiment;

FIG. 10 is an elevational section of a vibration-attenuation device according to a sixth representative embodiment;

FIG. 11 is an elevational section of a vibration-attenuation device according to a seventh representative embodiment; and

FIG. 12 is a schematic of an inverted-pendulum-relationship configuration provided by vibration-attenuation devices described herein.

### DETAILED DESCRIPTION OF SEVERAL EMBODIMENTS

As used herein, “vibration attenuation” encompasses attenuation not only of “vibration” as this term is generally understood in the art (i.e., a continuing periodic change in displacement of a mass relative to a reference), but also attenuation of any of various types of movement of one mass relative to another mass. I.e., the attenuated movement is not limited to reduced continuing periodic motion.

For ease of explanation and depiction, the “support axis” extends in a Z-direction between two masses and serves as a reference axis for any of the various embodiments described herein. Mutually perpendicular directions that are perpendicular to the Z-direction are X- and Y-directions. The X- and Y-directions define a plane, termed the “XY plane,” to which the support axis is perpendicular.

As used herein, “lateral” generally means sideways relative to the support axis. “Lateral” motion or “lateral” orientation in this regard includes motion and orientation, respectively, in a direction perpendicular to the support axis, and also includes motion and orientation, respectively, in a direction nearly perpendicular to the support axis, taking into account any existing or applied tilt relative to the support axis, as described below. Similarly, “transverse” generally means crosswise relative to the support axis. For example, the XY plane is transverse to the Z-axis or to the support axis. A “transverse” orientation in this regard includes an orientation in a direction perpendicular to the support axis, and also includes orientations in respective directions nearly perpendicular to the support axis, taking into account any existing or applied tilt relative to the support axis, as described below.

As used herein, “tilt stiffness” generally means the resistance to tilt or angular displacement between two masses. A higher tilt stiffness indicates a higher re-centering moment (i.e., a relatively smaller force may be applied to return the mass to the center).

Tilt stiffness should be distinguished from “lateral stiffness.” “Lateral stiffness” refers to the resistance of the disclosed vibration-attenuation devices to motion in a direction that generally is lateral to a support or load axis of the device. The devices described herein can exhibit positive, zero, or negative lateral stiffness.

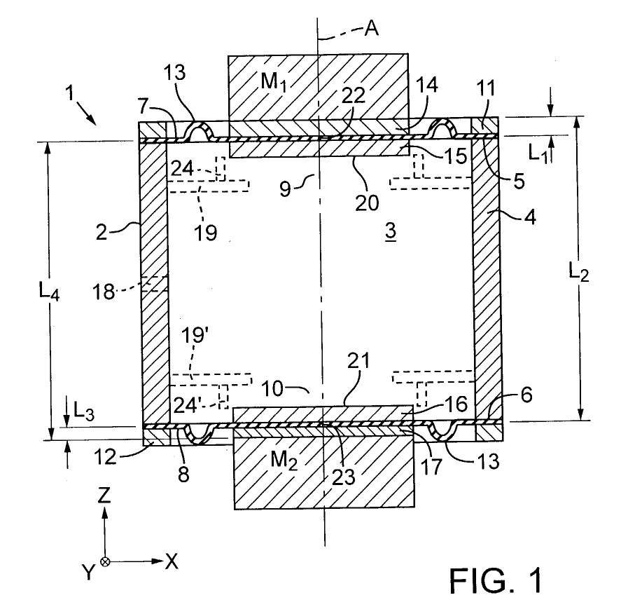

FIGS. 1-3 and 8-12 depict various representative embodiments of vibration-attenuation devices. In each of FIGS. 1-3 and 8-12, the vibration-attenuation device is situated between and contacts a first mass M₁ and a second mass M₂. By way of example, the masses M₁ and M₂ can be respective portions of a machine between which it is desired to attenuate vibration, or either mass can be a floor of a building and the other mass can be a machine or portion of a machine. In FIGS. 1-3 and 8-12 the mass M₁ can be regarded as the mass that is “isolated” from the mass M₂ by the device. The mass M₂ is attached to the ground or supported by some other means such as another vibration-attenuation device.

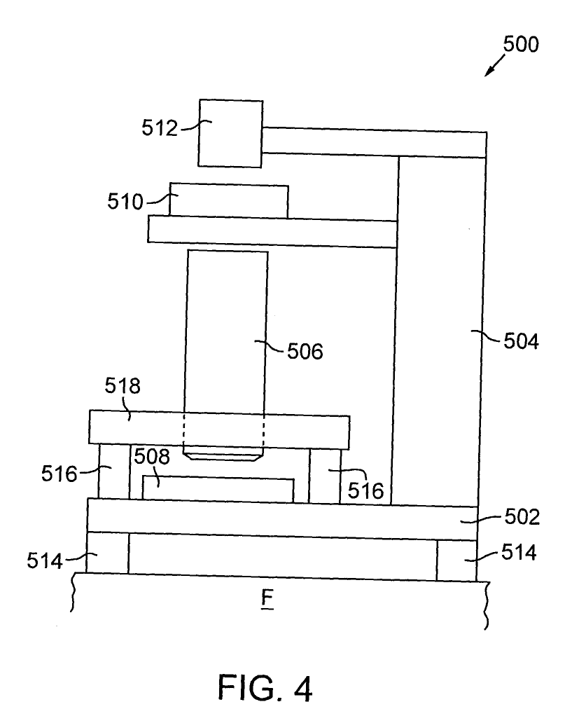

It should be noted that, for simplicity, only one respective vibration-attenuation device is shown in each of FIGS. 1-3 and 8-12. It will be understood that, in these various respective embodiments, at least three vibration-attenuation devices can be used as described below with regard to FIG. 4.

The devices are configured such that the first mass M₁ and the second mass M₂ are coupled together in an inverted pendulum relationship. A schematic of an inverted pendulum is depicted in FIG. 12. A vibration-attenuation device 670 is located between a mass M₁ (“isolated mass”) and a mass M₂ (“ground mass”) and aligned along a support axis A extending between mass M₁ and M₂. The vibration-attenuation device 670 includes an air spring 671 that is coupled to a first pivot element 672 and a second pivot element 673. The first pivot element 672 is coupled to the isolated mass M₁, and the second pivot element 673 is coupled to the ground mass M₂. The first and second pivot elements 672, 673 are arranged such that the pivot element associated with the isolated mass M₁ (i.e., the first pivot element 672) is located along the support axis A at a point that is “above” the location of the pivot element associated with the ground mass M₂ (i.e., second pivot element 673). Consequently, the air spring 671 is under compression. Due to the instability of this inverted pendulum configuration, the vibration-attenuation device 670 does not have a tendency to return mass M₁ to center whenever mass M₂ undergoes a lateral motion. In other words, the inverted pendulum configuration provides a negative or de-centering force with respect to lateral stability: However, the pivot elements (which can be diaphragms or analogous compliant members as discussed below) function as respective pivots or joints for the inverted pendulum. Such pivot elements provide a positive or centering force for restoring the mass M₁ to center that counters the negative force of the inverted pendulum configuration. The tilt stiffness of the pivot elements 672, 673 can be adjusted to match the negative force of the inverted pendulum configuration, resulting in a vibration-attenuation device that is overall laterally stable. Viewed another way, if the tilt stiffness of a given pivot element is known, then the negative force exerted by the inverted pendulum configuration can be adjusted by decreasing or increasing the length of the air spring.

The masses M₁ and M₂ and the vibration-attenuation device 670 may be aligned axially with each other along a support axis A extending parallel or substantially parallel to a Z-direction. In any of the embodiments of vibration-attenuation devices described below, the support axis A need not be on the respective axes of the masses M₁ and M₂ and the vibration-attenuation device, and the respective axes of the masses M₁ and M₂ and the vibration-attenuation device need not be aligned with each other. Also, the support axis A need not be aligned with the direction of acceleration due to gravity.

Referring to FIG. 1, a first representative embodiment of a vibration-attenuation device 1 is depicted that includes a housing 2 defining a chamber 3. The housing 2 includes a side-wall 4 and can have a cylindrical, rectangular, or other suitable geometric shape. The side wall 4 includes a first edge 5 and a second edge 6.

A flexible first diaphragm 7 and a flexible second diaphragm 8 extend across a first open end 9 of the housing 2 and a second open end 10 of the housing 2, respectively. The first diaphragm 7 and the second diaphragm 8 are in sealing engagement with the first edge 5 and the second edge 6, respectively. The first and second diaphragms 7, 8 may be attached or affixed to the side wall 4 of the housing 2 by any suitable fastening means. For example, a first sealing ring 11 may be provided for sealing the perimeter of the first diaphragm 7 circumferentially to the first edge 5. A second sealing ring 12 may be provided for sealing the perimeter of the second diaphragm 8 circumferentially to the second edge 6. The first and second sealing rings 11, 12 can be attached to the respective first and second edges 5, 6 using screws, an adhesive, or other suitable fastening means. Thus, the first diaphragm 7 and the second diaphragm 8 further define, and complete the enclosure of, the chamber 3.

The first and second diaphragms 7, 8 desirably include a rolling convolution 13 or analogous feature permitting the first and second diaphragms 7, 8 to flex in the axial direction (Z-direction) without deforming substantially. As shown, the first mass M₁ is situated adjacent the obverse surface of the first diaphragm 7. Similarly, the second mass M₂ is situated adjacent the obverse surface of the second diaphragm 8. To such end, a central portion of the first diaphragm 7 is sandwiched between first and second mounting plates 14, 15, respectively, wherein the first mass M₁ contacts the first mounting plate 14. The second mounting plate 15 defines a first surface 20 facing the chamber 3. A central portion of the second diaphragm 8 is sandwiched between third and fourth mounting plates 16, 17, respectively, wherein the second mass M₂ contacts the fourth mounting plate 17. The third mounting plate 16 defines a first surface 21 facing the chamber 3. Alternatively, the first and second diaphragms 7, 8 may be adhered to the first and fourth mounting plates 14, 17, respectively, thereby obviating the need for the second and third mounting plates 15, 16. Thus, the first mass M₁ and the mounting plates 14, 15 collectively function in the manner of a first piston relative to the chamber 3 (and the second mass M₂ and the mounting plates 16, 17 collectively function in the manner of a second piston relative to the chamber 3), but have more freedom of motion (e.g., limited range of tilt, yaw, and roll relative to the support axis A) than a conventional piston. The first surfaces 20, 21 of the mounting plates 15, 16, respectively, function as respective piston surface areas.

During operation the chamber 3 is pressurized with a fluid, such as a gas (e.g., air), at a predetermined pressure (e.g., about 1.5 atmospheres to about 5 atmospheres). The gas is introduced into the chamber 3 via a port 18 defined in a portion of the side wall 4 of the housing 2. Thus, the side wall 4 of the housing 2 is unitary in that it is a continuous structure along its axial length. The port 18 may be connected via a conduit (not shown) to a suitable gas source (not shown). The source can be a regulated pressurized source if desired or necessary. The gas is introduced in the chamber 3 sufficiently to create the desired pressure in the chamber 3. The pressure applies a force against the first diaphragm 7 and the first surface 20 of the second mounting plate 15 sufficient to support the combined mass of the first mass M₁, the first and second mounting plates 14, 15 and the central portion of the first diaphragm 7 along the support axis A relative to the second mass M₂. The pressure also applies an equal and opposite force against the second diaphragm 8 and the first surface 21 of the third mounting plate 16, effectively transferring the weight of mass M₁ to mass M₂. The pressurized gas in the chamber 3 is an energy-storage medium for the vibration-attenuation device 1 in the manner of an air spring for attenuating transmission of vibration between the first mass M₁ and the second mass M₂.

A “hard-stop” may be provided in the vibration-attenuation device 1 to prevent excessive collapse of the mass M₁ toward the mass M₂ in the event of insufficient pressure in the chamber 3. In this regard, for example, the side wall 4 can be provided with a first shelf 19 extending inwardly and perpendicularly to the axis A in FIG. 1 and having a distal end situated “beneath” the second mounting plate 15 sufficiently to stop excessive “downward” motion of the mass M₁. The first shelf 19 can also define a first flange 24 to prevent excessive lateral motion of the first mass M₁. The side wall 4 can also be provided with a second shelf 19′ extending inwardly and perpendicularly to the axis A in FIG. 1 and having a distal end situated “above” the third mounting plate 16 sufficiently to stop excessive “upward” motion of the mass M₂. The second shelf 19′ can also define a second flange 24′ to prevent excessive lateral motion of the first mass M₁. Such stops also would prevent excess stress on the flexible first and second diaphragms 7, 8, respectively, in the event of insufficient pressure in the chamber 3.

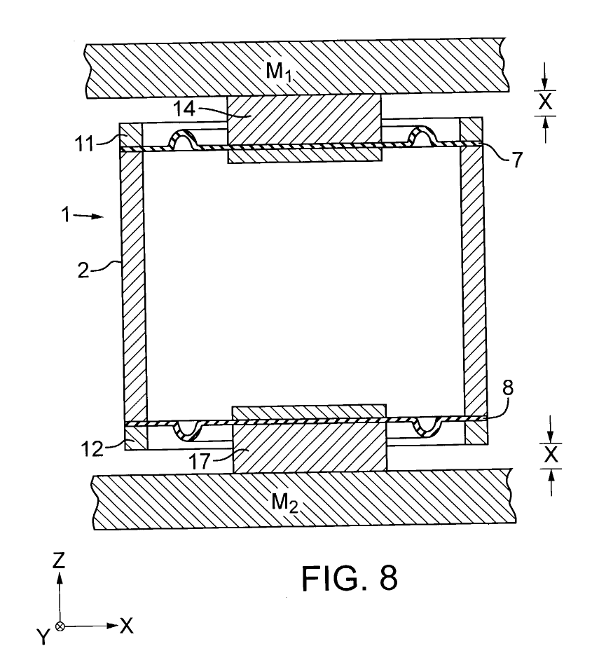

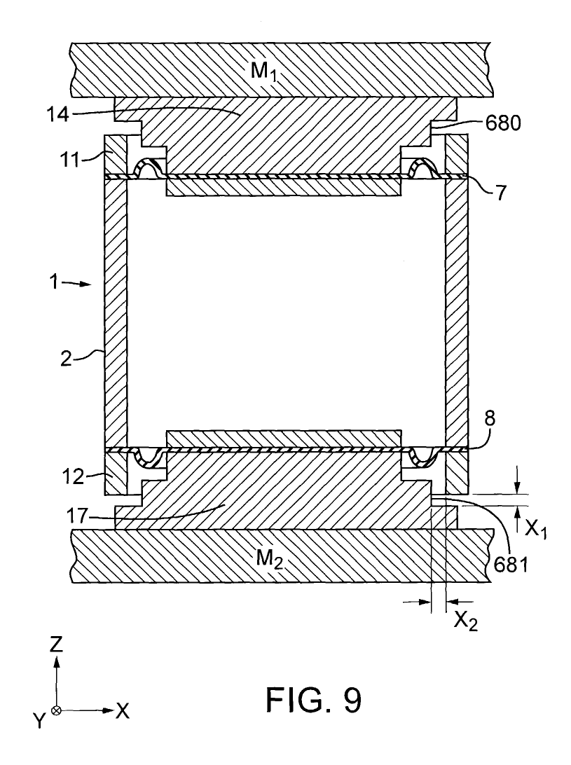

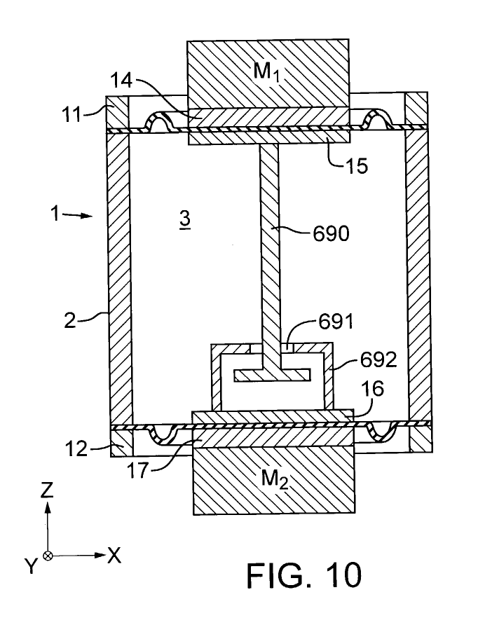

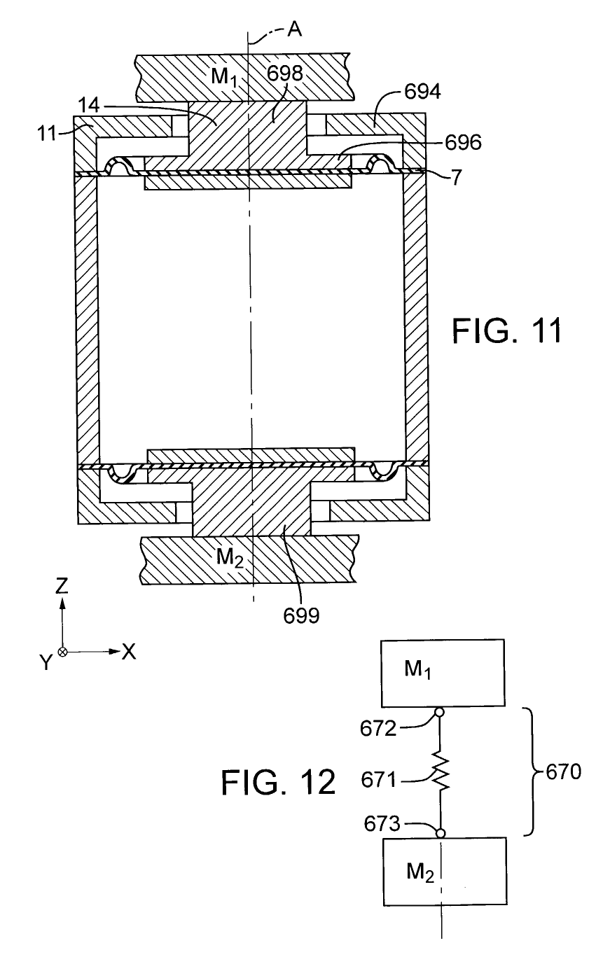

Further examples of hard-stop variations are shown in FIGS. 8-11. In FIGS. 8-11, like-numbered elements correspond to respective elements shown in FIG. 1. In the device shown in FIG. 8, the outer surfaces of first and second sealing rings 11, 12 serve as hard-stops against the surfaces of the masses M₁ and M₂, respectively. The clearance distance “x” limits the relative movement of the masses M₁ and M₂ in the Z-direction. In the device shown in FIG. 9, the first and fourth mounting plates 14, 17 each include a stepped portion 680, 681, respectively. Each stepped portion 680, 681 defines a respective surface profile that is complementary to the surface profile of the respective associated first and second sealing rings 11, 12. The clearance distance “x₁” limits the relative movement of the masses M₁ and M₂ in the Z-direction. The clearance distance “x₂” limits the relative movement of the masses M₁ and M₂ in the X-direction. In the device shown in FIG. 10, there is provided a T-shaped element 690 affixed to the second mounting plate 15 and axially extending into the chamber 3. The T-shaped end of the T-shaped element 690 is received within an opening 691 defined in an enclosure 692. The enclosure 692 is affixed to the third mounting plate 16 and axially extends into the chamber 3. It is readily apparent that the T-shaped end of the T-shaped element 690 can engage with the enclosure 692 to limit the relative movement of the masses M₁ and M₂ in the X-, Y-, and Z-directions. Another added feature of the device in FIG. 10 is that over-extension or separation of the mass M₁ relative to the mass M₂ is prevented. In the device shown in FIG. 11, the first sealing ring 11 defines or has attached thereto a first flange 694 that extends radially toward the axis A of the device 1. Similarly, the second sealing ring 12 defines or has attached thereto a second flange 695 that extends radially toward the axis A of the device 1. The first mounting plate 14 defines a first step portion 696 and a first column portion 698. Similarly, the fourth mounting plate 17 defines a second step portion 697 and a second column portion 699. The first flange 694 of the first sealing ring 11 can engage with the first step portion 696 to prevent excessive movement of the mass M₁ in the Z-direction and with the first column portion 698 to prevent excessive movement of the mass M₁ in the X-direction. In a similar manner, the second flange 695 of the second sealing ring 12 can prevent excessive movement of the mass M₂.

Returning to FIG. 1, whenever the second mass M₂ is subjected to a lateral motion in the X- and/or Y-direction, the housing 2 can pivot or rotate about a first rotation locus 22 and/or a second rotation locus 23 such that the first mass M₁ can remain stationary in a transverse direction. The first rotation locus 22 is located in the plane in which the first diaphragm 7 lies, and typically is on the support axis A. The second rotation locus 23 is located in the plane in which the second diaphragm 8 lies, and typically is on the support axis A. However, whenever the housing 2 rotates, the fluid pressure in chamber 3 creates a lateral force on the housing 2, and the first and second diaphragms 7, 8 allow the housing 2 to shift slightly laterally relative to the first and second pistons. The first and second rotation loci 22, 23, respectively, correspondingly shift laterally so that they are not exactly on the support axis A. The axial distance “L₁” between the first rotation locus 22 and the first mass M₁ is less than the axial distance “L₂” between the second rotation locus 23 and the first mass M₁. Similarly, the axial distance “L₃” between the second rotation locus 23 and the second mass M₂ is less than the axial distance “L₄” between the first rotation locus 22 and the second mass M₂. The specific locations of, and mechanisms for providing, the rotation loci can vary from that shown in FIG. 1.

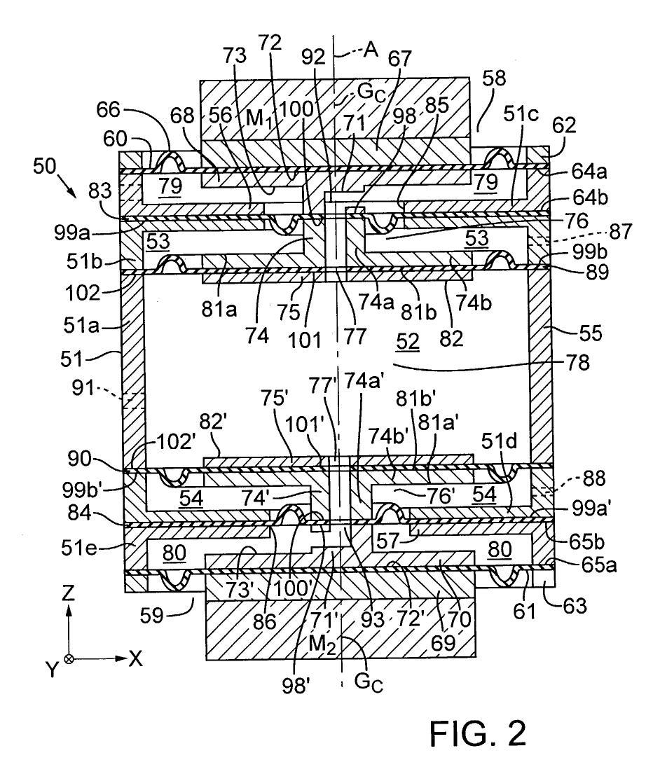

A second representative embodiment of a vibration-attenuation device 50 is depicted in FIG. 2. The vibration-attenuation device 50 includes a housing 51 enclosing a pressure chamber 52, a first partition chamber 53, and a second partition chamber 54. The housing 51 can have a cylindrical, rectangular, or other suitable geometric design. The housing 51 includes five, coaxially-arranged sections or parts: a central section 51a, a first inner flange section 51b, a first outer flange section 51c, a second inner flange section 51d, and a second outer flange section 51e. These five sections of the housing 51 collectively define a side wall 55. The first outer flange section 51c defines a first open end 58. The second outer flange section 51e defines a second open end 59. The first inner flange section 51b and the first outer flange section 51c are positioned coaxially adjacent to each other and together define a first radially inwardly extending flange 56. The second inner flange section 51d and the second outer flange section 51e are positioned coaxially adjacent to each other and together define a second radially inwardly extending flange 57.

A flexible first outer diaphragm 60 extends across the first open end 58 of the first outer flange section 51c, and a flexible second outer diaphragm 61 extends across the second open and 59 of the second outer flange section 51e. The first outer diaphragm 60 is in sealing engagement with a first edge 64a of the first outer flange section 51c. The second outer diaphragm 61 is in sealing engagement with a first edge 65a of the second outer flange section 51e. The first and second outer diaphragms 60, 61 may be attached or affixed to the first edges 64a, 65a, respectively, by any suitable fastening means such as an adhesive. For example, a first sealing ring 62 may be provided for sealing the perimeter of the first outer diaphragm 60 circumferentially to the first edge 64a of the first outer flange section 51c, and a second sealing ring 63 may be provided for sealing the perimeter of the second outer diaphragm 61 circumferentially to the first edge 65a of the second outer flange section 51e. The first and second sealing rings 62, 63, respectively, can be attached to the respective first edges 64a, 65a using screws, an adhesive, or other suitable fastening means.

As shown, the first mass M₁ is situated adjacent the obverse surface of the first outer diaphragm 60. Similarly, the second mass M₂ is situated adjacent the obverse surface of the second outer diaphragm 61. To such end, a central portion of the first outer diaphragm 60 is sandwiched between a first mounting plate 67 and a second mounting plate 68, wherein the first mass M₁ contacts the first mounting plate 67. Similarly, a central portion of the second outer diaphragm 61 is sandwiched between a third mounting plate 69 and a fourth mounting plate 70, wherein the second mass M₂ contacts the third mounting plate 69.

The second mounting plate 68 defines a first surface 72 that contacts the first outer diaphragm 60. The second mounting plate 68 also defines a second surface 73 opposing the first surface 72. The second mounting plate 68 further defines a central column 71 that is contiguous with the second surface 73 and axially extends toward the center of the vibration-attenuation device 50. The central column 71 defines an edge 98. Similarly, the fourth mounting plate 70 defines a first surface 72′ that contacts the second outer diaphragm 61. The fourth mounting plate 70 also defines a second surface 73′ opposing the first surface 72′. The fourth mounting plate 70 further defines a central column 71′ that is contiguous with the second surface 73′ and axially extends towards the center of the vibration-attenuation device 50. The central column 71′ defines an edge 98′. As explained in more detail below, each of the second surfaces 73, 73′ functions as a respective piston surface area.

A central mounting member 74 is located coaxially adjacent to the central column 71 of the second mounting plate 68. The central mounting member 74 includes a column section 74a and a flange section 74b. The flange section 74b defines a first surface 81a and an opposing second surface 81b. Similarly, a central mounting member 74′ is located coaxially adjacent to the central column 71′ of the fourth mounting plate 70. The central mounting member 74′ includes a column section 74a′ and a flange section 74b′. The flange section 74b′ defines a first surface 81a′ and an opposing second surface 81b′.

The second surface 73 of the second mounting plate 68, the central column 71 of the second mounting plate 68, the column section 74a of the central mounting member 74, and the first surface 81a of the central mounting member 74 together define a cavity 76 that receives a distal end 85 of the first flange 56. Similarly, the second surface 73′ of the fourth mounting plate 70, the central column 71′ of the fourth mounting plate 70, the column section 74a′ of the central mounting member 74′, and the first surface 81a′ of the central mounting member 74′ together define a cavity 76′ that receives a distal end 86 of the second flange 57.

A flexible first central diaphragm 83 and a flexible second central diaphragm 84 extend, respectively, across respective annular spaces between the distal end 85, 86 of the first and second flanges 56, 57 and the column sections 74a, 74′a of the respective central mounting members 74, 74′, respectively. The first central diaphragm 83 is sandwiched between, and is in sealing engagement circumferentially with, a second edge 64b of the first outer flange section 51c and a first edge 99a of the first inner flange section 51b. A central portion of the first central diaphragm 83 is sandwiched between, and is in sealing engagement with, the edge 98 of the central column 71 of the second mounting plate 68 and an edge 100 of the column section 74a of the central mounting member 74. Similarly, the second central diaphragm 84 is sandwiched between, and is in sealing engagement circumferentially with, a second edge 65b of the second outer flange section 51e and a first edge 99a′ of the second inner flange section 51d. A central portion of the second central diaphragm 84 is sandwiched between, and is in sealing engagement with the edge 98′ of the central column 71′ of the fourth mounting plate 70 and an edge 100′ of the column section 74a′ of the central mounting member 74′. The first and second central diaphragms 83, 84 may be attached or affixed thereto by any suitable fastening means as described above in connection with the first and second outer diaphragms 60, 61, respectively.

A first head-mounting ring 75 defines a mounting surface 101 facing the second surface 81b of the flange section 74b of the central mounting member 74. The first head-mounting ring 75 also defines a second surface 82 opposing the mounting surface 101 and facing a center region 78 of the pressure chamber 52. Similarly, a second head-mounting ring 75′ defines a mounting surface 101′ facing the second surface 81b′ of the flange section 74b′ of the central mounting member 74′. The second head-mounting ring 75′ also defines a second surface 82′ opposing the mounting surface 101′ and facing the center region 78 of the pressure chamber 52. As explained in more detail below, each second surface 82, 82′ functions as a respective piston surface area.

A flexible first inner diaphragm 89 extends across a respective annular space between the first head-mounting ring 75 and the side wall 55 of the housing 51, and a flexible second inner diaphragm 90 extends across a respective annular space between the second head-mounting ring 75′ and the side wall 55. The first inner diaphragm 89 is sandwiched between, and is in sealing engagement circumferentially with, a first edge 102 of the central portion 51a of the housing 51 and a second edge 99b of the first inner flange section 51b. A central portion of the first inner diaphragm 89 is sandwiched between, and is in sealing engagement with, the second surface 81b of the of the flange section 74b of the central mounting member 74 and the mounting surface 101 of the first head-mounting ring 75. Similarly, the second inner diaphragm 90 is sandwiched between, and is in sealing engagement circumferentially with, a second edge 102′ of the central portion 51a of the housing 51 and a second edge 99b′ of the second inner flange section 51d. A central portion of the second inner diaphragm 90 is sandwiched between, and is in sealing engagement with, the second surface 81b′ of the of the flange section 74b′ of the central mounting member 74′ and the mounting surface 101′ of the second head-mounting ring 75′. The first and second inner diaphragms 89, 90 may be attached or affixed thereto by any suitable fastening means as described above in connection with the first and second outer diaphragms 60, 61, respectively.

A passage 77 that fluidly communicates the center region 78 of the pressure chamber 52 with a first distal section 79 of the pressure chamber 52 is defined by the first head-mounting ring 75, the first inner diaphragm 89, the central mounting member 74, the first central diaphragm 83, and the second mounting plate 68. Similarly, a passage 77′ that fluidly communicates the center region 78 with a second distal section 80 of the pressure chamber 52 is defined by the second head-mounting ring 75′, the second inner diaphragm 90, the central mounting member 74′, the second central diaphragm 84, and the fourth mounting plate 70. The second and fourth mounting plates 68, 70, central mounting members 74, 74′, and the head-mounting rings 75, 75′ typically have a radially circumferential shape so that they can be disposed within the housing 51.

As described above, the vibration-attenuation device 50 includes six diaphragms 60, 61, 83, 84, 89, and 90, with three diaphragms 60, 83, and 89 associated with the first mass M₁ and three diaphragms 61, 84, and 90 associated with the second mass M₂. The first central diaphragm 83 and the first inner diaphragm 89 define (along with the first inner flange section 51b and the central mounting member 74) the first partition chamber 53. The second central diaphragm 84 and the second inner diaphragm 90 define (along with the second inner flange section 51d and the central mounting member 74′) the second partition chamber 54. Each of the diaphragms illustrated in FIG. 2 desirably includes a respective rolling seal 66 (rolling convolution) or analogous feature permitting the diaphragms to flex in the axial direction (Z-direction) without deforming.

The first and second partition chambers 53, 54 are adjacent to and serve to separate the center region 78 from the first and second distal sections 79, 80, respectively, of the pressure chamber 52. A first port 87 is defined in the side wall 55 for introducing a fluid into, or establishing a vacuum in, the first partition chamber 53. The fluid may be a gas such as air at atmospheric or sub-atmospheric pressure. Similarly, a second port 88 is defined in the side wall 55 for introducing a fluid into, or establishing a vacuum in, the second partition chamber 54. The partition chambers 53, 54 are compliant interfaces between the center region 78 and the distal sections 79, 80 of the pressure chamber 52.

During operation the pressure chamber 52 is pressurized with a fluid, such as a gas (e.g., air), at a predetermined pressure (e.g., about 1.5 atmospheres to about 5 atmospheres). The gas is introduced into the pressure chamber 52 via a port 91 defined in a portion of the side-wall 55 of the central portion 51a of the housing 51. The port 91 may be connected via a conduit to a suitable gas source (not shown). The source can be a regulated pressurized source if desired or necessary. The gas is introduced in the pressure chamber 52 sufficiently to create the desired pressure in the center region 78 and, via the passages 77, 77′, in the respective first and second distal sections 79, 80. The pressure in the center region 78 applies a force against the combination of the first inner diaphragm 89 and the second surface 82 of the first head-mounting ring 75 (collectively referred to herein as the “first piston surface area”). The pressure in the first distal section 79 applies a force to the combination of the first outer diaphragm 60 and the second surface 73 of the second mounting plate 68 (collectively referred to herein as the “second piston surface area”). The combined forces applied to the first and second piston surface areas sufficiently support the combined mass of the first mass M₁, the first mounting plate 67, the second mounting plate 68, the central mounting member 74, and the first head-mounting ring 75 along the support axis A relative to the second mass M₂. Thus, the first mass M₁, the first mounting plate 67, the second mounting plate 68, the central mounting member 74, and the first head-mounting ring 75 collectively function in the manner of a first piston (having two piston surfaces) relative to the pressure chamber 52, but have more freedom of motion (e.g., limited range of tilt, yaw, and roll relative to the support axis A) than a conventional piston. Similarly, the pressure in the center section 78 applies a force against the combination of the second inner diaphragm 90 and the second surface 82′ of the second head-mounting ring 75′ (collectively referred to herein as the “third piston surface area”). The pressure in the second distal section 80 applies a force to the combination of the second outer diaphragm 61 and the second surface 73′ of the fourth mounting plate 70 (collectively referred to herein as the “fourth piston surface area”). The combined forces applied to the third and fourth piston surfaces are equal to and opposite that of the combined forces applied to the first and second piston surfaces. Thus, the second mass M₂, the third mounting plate 69, the fourth mounting plate 70, the central mounting member 74′, and the second head-mounting ring 75′ collectively function in the manner of a second piston (having two piston surfaces) relative to the pressure chamber 52, but have more freedom of motion (e.g., limited range of tilt, yaw, and roll relative to the support axis A) than a conventional piston. The pressurized gas in the pressure chamber 52 is an energy-storage medium for the vibration-attenuation device 50 in the manner of an air spring for attenuating transmission of vibration between the first mass M₁ and the second mass M₂.

For a given diameter, the available piston surface area of the embodiment shown in FIG. 2 is approximately double that of the available piston surface area of the embodiment shown in FIG. 1. As described above, the first and second distal sections 79, 80 of the pressure chamber 52 provide an additional piston surface area associated with masses M₁ and M₂, respectively. Thus, the vibration-attenuation device 50 can support a greater mass (i.e., have a greater load capacity) since force applied to a surface is equal to pressure multiplied by the surface area.

Although the vibration-attenuation device shown in FIG. 2 includes double piston surface areas at both open ends of the housing, a device could be provided with a double piston configuration at only one open end and a single piston configuration such as in FIG. 1 (or other configuration) at the other open end. The particular arrangement or design of the mounting plates and/or flanges could also vary from that illustrated in FIG. 2.

Further with respect to the embodiment of FIG. 2, whenever the second mass M₂ is subjected to a lateral motion in the X- and/or Y-direction relative to the first mass M₁, the housing 51 rotates relative to the first mass M₁ about a first rotation locus 92 and rotates relative to the second mass M₂ about a second rotation locus 93. The first rotation locus 92 typically is in or near the plane occupied by the first central diaphragm 83. The second rotation locus 93 typically is in or near the plane occupied by the second central diaphragm 84. In other words, the housing 51 rotates about the first and second rotation loci 92, 93, respectively, such that the first mass M₁ can remain stationary in a transverse direction whenever the second mass M₂ undergoes a lateral motion. The specific locations of, and mechanisms for providing, the rotation loci can vary from that shown in FIG. 2.

The three respective diaphragms associated with each piston may cooperate to stabilize the inverted pendulum movement of the vibration-attenuation device 50. For example, rotation of the housing 51 about the first piston (i.e., the second mounting plate 68, the central mounting member 74, and the first head-mounting ring 75) will compress a portion of the first outer diaphragm 60 and extend a corresponding portion of the first inner diaphragm 89. The first central diaphragm 83 typically will not undergo any substantial compression or extension. The counteracting forces of the compression and extension of the first outer diaphragm 60 and the first inner diaphragm 89 increase the tilt stiffness of the rotation around the first rotation locus 92 without increasing the overall lateral stiffness of the vibration-attenuation device 50.

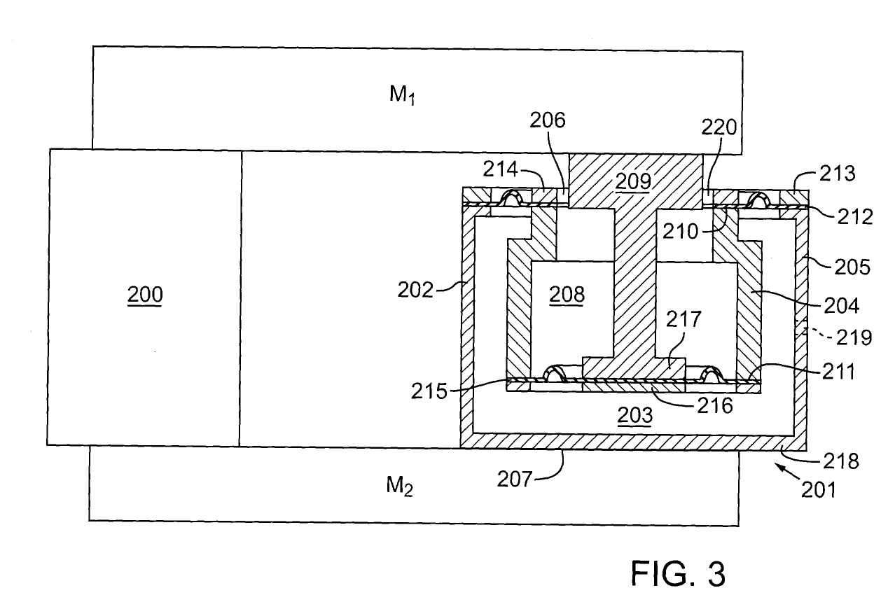

A third representative embodiment of a vibration-attenuation configuration is depicted in FIG. 3. The first mass M₁ is supported by a first vibration-attenuation device 200 and by a second vibration-attenuation device 201. The first vibration-attenuation device 200 is depicted schematically and may be an inverted pendulum device such as, for example, a device as illustrated in FIG. 1 or FIG. 2. The parallel arrangement of the first vibration-attenuation device 200 and the second vibration-attenuation device 201 provides a system support that has substantially zero lateral stiffness while retaining adequate tilt stiffness. In particular, the inverted pendulum configuration of the first vibration-attenuation device 200 lowers the lateral stiffness of the regular pendulum configuration of the second vibration-attenuation device 201, and the regular pendulum configuration of the second vibration-attenuation device 201 increases the tilt stiffness of the inverted pendulum configuration of the first vibration-attenuation device 200.

The second vibration-attenuation device 201 includes a housing 202 defining a pressure chamber 203 and enclosing an inner cylinder 204. The housing 202 includes a side wall 205, an open end 206, a closed end 207, and a base 218. The base 218 is adjacent the second mass M₂. The housing 202 can have a cylindrical, rectangular, or other suitable geometric design. The inner cylinder 204 defines an inner chamber 208, a first edge 210, and a second edge 211 located at the opposite axial end from the first edge 210. The inner cylinder 204 also encloses a mounting support 209. The mounting support 209 is positioned adjacent the first mass M₁.

A flexible annular diaphragm 212 extends across an opening between the side wall 205 and the first edge 210 of the inner cylinder 204. The annular diaphragm 212 is in sealing engagement with the side wall 205 and the first edge 210. The annular diaphragm 212 may be attached or affixed to the side wall 205 and the first edge 210 by any suitable fastening means such as screws and/or an adhesive. For example, a first sealing ring 213 may be provided for sealing the outside perimeter of the annular diaphragm 212 circumferentially to the side wall 205. A second sealing ring 214 may be provided for sealing the inside perimeter of the annular diaphragm 212 circumferentially to the first edge 210.

A central portion of a flexible base diaphragm 215 is sandwiched between a mounting plate 216 and a base portion 217 of the mounting support 209. The base diaphragm 215 extends across an annular opening between the base portion 217 and the second edge 211 of the inner cylinder 204. In one embodiment the flexible portion of the annular diaphragm 212 has a diameter equal to the diameter of the flexible portion of the annular diaphragm 215. This configuration results in the pressurized areas of each diaphragm 212, 215 being equal to each other and the net Z-direction force on the inner cylinder 204 being approximately zero. In alternative embodiments the respective diameters of the flexible portions of the diaphragms 212, 215 intentionally can be different from each other so as to provide, for example, support for the mass of the inner cylinder 204.

During operation the pressure chamber 203 is pressurized with a fluid, such as a gas (e.g., air), at a predetermined pressure (e.g., about 1.5 atmospheres to about 5 atmospheres). The gas is introduced into the pressure chamber 203 via a port 219 defined in a portion of the side wall 205 of the housing 202. The port 219 may be connected via a conduit to a suitable gas source (not shown). The source can be a regulated pressurized source if desired or necessary. The gas is introduced in the pressure chamber 203 sufficiently to create the desired pressure. The pressure against the annular diaphragm 212 and the base diaphragm 215 is sufficient for supporting the combined mass of a portion of the first mass M₁, the mounting support 209, and the inner cylinder 204 relative to the second mass M₂. An annular opening 220 between the mounting support 209 and the inner cylinder 204 communicates between ambient atmosphere and the inner chamber 208. The pressurized gas in the pressure chamber 203 is an energy-storage medium for the second vibration-attenuation device 201 in the manner of an air spring for attenuating transmission of vibration between the first mass M₁ and the second mass M₂.

In any of the representative embodiments described above, the respective diaphragms can be any of various commercially available flexible materials such as elastomers (e.g., a rubber composition) used, for example, in air isolators as used in the automotive industry. The housing, mounting plates, and mounting pistons described above can be made of any of various rigid materials, depending upon the conditions of use and other factors. For example, these components can be fabricated from any of various metals such as steel or aluminum, ceramic materials, or rigid polymeric materials. The housing, mounting plates, and mounting pistons need not be made of the same material.

As noted above, vibration-attenuation devices as disclosed herein can be used in any of various types of machines in which the particular capabilities of the devices can be exploited beneficially. Due to the extremely high-accuracy performance demanded of current stepper machines, an especially important application of the subject vibration-attenuation devices is in a stepper machine.

A stepper machine (also generally termed a “lithographic exposure apparatus”) 500 is depicted in FIG. 4 showing an exemplary manner in which vibration-attenuation devices can be employed. It will be understood, however, that the FIG. 4 configuration is not intended to be limiting in any way. The vibration-attenuation devices can be utilized in any of various locations of the machine as conditions indicate.

In FIG. 4, the machine 500 includes a base 502 to which a support frame 504 is attached. Mounted to the support frame 504 is a wafer-stage assembly 508 situated and configured to hold a wafer or other suitable substrate for exposure at an appropriate location relative to a projection-optical system 506. Also mounted to the support frame 504 are the projection-optical system 506 and, situated upstream of the projection-optical system 506, a reticle-stage assembly 510 configured to hold a pattern-defining reticle relative to the projection-optical system 506. Situated upstream of the reticle-stage assembly 510 is an illumination-optical system 512 that also can be supported by the support frame 504. Between the base 502 and the floor F of a room enclosing the machine 500 are multiple vibration-attenuation devices 514 configured, for example, according to any of the representative embodiments described above. For best results, the number of devices 514 situated between the base 502 and floor F is at least three (e.g., four, wherein a respective device 514 is located at each corner of the base 502).

FIG. 4 also depicts vibration-attenuation devices 516 situated between the optical-system support frame 518 and the base 502. For best results, the number of vibration-attenuation devices 516 is at least three. The vibration-attenuation devices 514, 516 can be configured according to any of the representative embodiments described above.

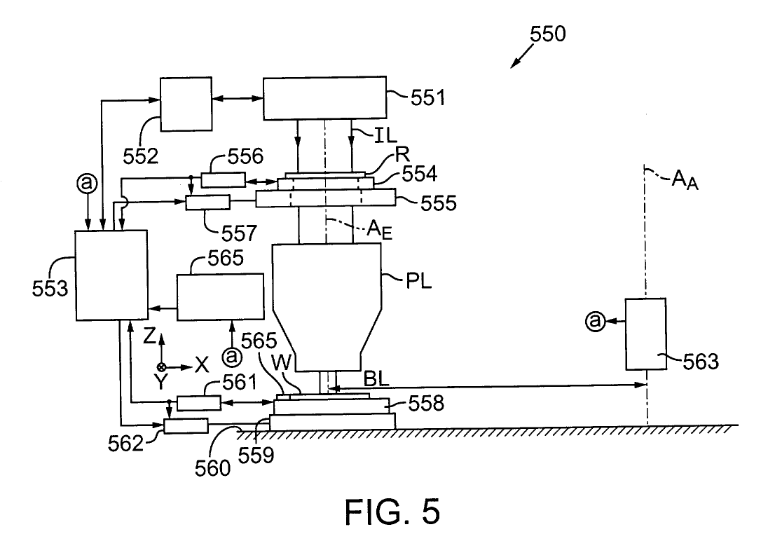

A stepper machine 550 with which any of the foregoing embodiments can be used is depicted in more detail in FIG. 5. Many of the components and their interrelationships in this apparatus are known in the art, and hence are not described in detail herein.

For exposure an illumination “light” IL is produced and directed by an illumination-optical system 551 to irradiate a selected region of a reticle R. The illumination-optical system 551 typically comprises an exposure-light source (e.g., ultraviolet light source, extreme ultraviolet light source, charged-particle-beam source), an integrator, a variable field stop, and a condenser lens system or the like. An image of the irradiated portion of the reticle R is projected by a projection-optical system PL onto a corresponding region of a wafer W or other suitable substrate. So as to be imprinted with the image, the upstream-facing surface of the wafer W is coated with a suitable resist. The projection-optical system PL has a projection magnification β (β=⅕ or ¼, for example). An exposure controller 552 is connected to the illumination-optical system 551 and operates to optimize the exposure dose on the wafer W, based on control data produced and routed to the exposure controller 552 by a main control system 553.

In the stepper machine 550 depicted in FIG. 5, the Z-axis extends parallel to an optical axis A_{E} of the projection-optical system PL, the X-axis extends laterally across the plane of the page perpendicularly to the Z-axis, and the Y-axis extends perpendicularly to the plane of the page. The reticle R is mounted on a reticle stage 554, which is operable to position the reticle R relative to a reticle-stage base 555 in the X- and Y-axis directions. The reticle stage 554 also is operable to rotate the reticle R as required about the Z-axis, based on control data routed to the reticle stage 554 by a reticle-stage driver 557 connected to the reticle stage 554. The control data produced by the reticle-stage driver 557 is based upon reticle-stage coordinates as measured by a laser interferometer 556.

The wafer W is mounted to a wafer holder such as a wafer chuck (not shown, but well-understood in the art) that in turn is mounted to a wafer table 558. The wafer table 558 is mounted to a wafer stage 559 configured to move the wafer table 558 (with wafer chuck) in the X- and Y-axis directions relative to a base 560 supported on vibration-attenuation devices (not shown, but see FIG. 4) relative to a floor or the like. The wafer table 558 is operable to move the wafer chuck and wafer W in the Z-axis direction (focusing direction) relative to the projection-optical system PL. The wafer table 558 also is operable, as part of an auto-focus system (not shown, but well-understood in the art) to tilt the wafer W relative to the optical axis A_{E} so as to place the wafer surface properly for imaging by the projection-optical system PL. The wafer stage 559 is operable to move the wafer table 558 in a stepping manner in the X- and Y-axis directions, as controlled by a wafer-stage driver 562 connected to the wafer stage 559. The wafer-stage driver 562 receives data concerning the X-Y position of the wafer table 558 as measured by a laser interferometer 561. Exposure of individual shot areas on the wafer W is achieved by performing a respective stepping motion of the wafer stage 559 followed by exposure of an image of the pattern on the reticle R in a step-and-repeat manner.

Typical fabrication processes for microelectronic devices and displays involve multiple microlithography steps of respective patterns onto the wafer in a superposed manner. After exposing a pattern of a particular layer onto the wafer surface, and at time of exposing a pattern of a subsequent layer, alignment of the reticle R and wafer W should be performed before exposing the subsequent layer. For such a purpose, a reference-mark member 565, defining one or more reference marks, is provided on the wafer table 558. The reticle R is aligned with the reference-mark member 565, based upon alignment measurements obtained using a reticle-alignment microscope (not shown). An alignment sensor 563 (desirably an image-processing type) is situated adjacent the projection-optical system PL and has an axis A_{A} that is parallel to the axis A_{E}. The alignment sensor 563 desirably comprises an image-pickup device (not detailed) that produces an image signal that is routed to an alignment-signal processor 564. The alignment-signal processor 564 determines respective alignment positions of alignment marks on the wafer W relative to corresponding index marks. The image-processing performance of the alignment-signal processor 564 is disclosed in, for example, U.S. Pat. No. 5,493,403, incorporated herein by reference. An exemplary structure of the reference-mark member 565 and its use for alignment purposes and the like are disclosed in U.S. Pat. No. 5,243,195, incorporated herein by reference.

The stepper machine 550 shown in FIG. 5 can be any of various types of microlithography apparatus. For example, as an alternative to operating in a “step-and-repeat” manner characteristic of steppers, the machine 550 can be a scanning-type microlithography apparatus operable to expose the pattern from the reticle R to the wafer W while continuously scanning both the reticle R and wafer W in a synchronous manner. During such scanning, the reticle R and wafer W are moved synchronously in opposite directions perpendicular to the optical axis A_{E}. The scanning motions of the reticle R and wafer W are performed by the respective stages 554, 559.

In contrast, a step-and-repeat microlithography apparatus performs exposure only while the reticle R and wafer W are stationary. If the microlithography apparatus is an “optical lithography” apparatus, the wafer W typically is in a constant position relative to the reticle R and projection-optical system PL during exposure of a given pattern field. After the particular pattern field is exposed, the wafer W is moved, perpendicularly to the optical axis A_{E} and relative to the reticle R, to place the next field of the wafer W into position for exposure. In such a manner, images of the reticle pattern are exposed sequentially onto respective fields on the wafer W.

Pattern-exposure apparatus as provided herein are not limited to microlithography apparatus for manufacturing microelectronic devices. As a first alternative, for example, the apparatus can be a liquid-crystal-device (LCD) microlithography apparatus used for exposing a pattern for a liquid-crystal display onto a glass plate. As a second alternative, the apparatus can be a microlithography apparatus used for manufacturing thin-film magnetic heads. As a third alternative, the apparatus can be a proximity-microlithography apparatus used for exposing, for example, a mask pattern. In this alternative, the reticle R and substrate W are placed in close proximity with each other and exposure is performed without having to use a projection-optical system PL.

The principles as described above further alternatively can be used with any of various other apparatus, including (but not limited to) other microelectronic-processing apparatus, machine tools, metal-cutting equipment, and inspection apparatus.

In any of various microlithography apparatus as described above, the source (in the illumination-optical system 551) of illumination “light” can be, for example, a g-line source (438 nm), an i-line source (365 nm), a KrF excimer laser (248 nm), an ArF excimer laser (193 nm), or an F₂ excimer laser (157 nm). Alternatively, the source can be of a charged particle beam such as an electron or ion beam, or a source of X-rays (including “extreme ultraviolet” radiation). If the source produces an electron beam, then the source can be a thermionic-emission type (e.g., lanthanum hexaboride or LaB₆ or tantalum (Ta)) of electron gun. If the illumination “light” is an electron beam, the pattern can be transferred to the wafer W from the reticle R or directly to the wafer W without using a reticle.

With respect to the projection-optical system PL, if the illumination light comprises far-ultraviolet radiation, the constituent lenses are made of UV-transmissive materials such as quartz and fluorite that readily transmit ultraviolet radiation. If the illumination light is produced by an F₂ excimer laser or EUV source, then the lenses of the projection-optical system PL can be either refractive or catadioptric, and the reticle R desirably is a reflective type. If the illumination “light” is an electron beam (as a representative charged particle beam), then the projection-optical system PL typically comprises various charged-particle-beam optics such as electron lenses and deflectors, and the optical path should be in a suitable vacuum. If the illumination light is in the vacuum ultraviolet (VUV) range (less than 200 nm), then the projection-optical system PL can have a catadioptric configuration with beam splitter and concave mirror, as disclosed for example in U.S. Pat. Nos. 5,668,672 and 5,835,275, incorporated herein by reference. The projection-optical system PL also can have a reflecting-refracting configuration including a concave mirror but not a beam splitter, as disclosed in U.S. Pat. Nos. 5,689,377 and 5,892,117, incorporated herein by reference.

Either or both the reticle stage 554 and wafer stage 559 can include respective linear motors for achieving the motions of the reticle R and wafer W, respectively, in the X-axis and Y-axis directions. The linear motors can be air-levitation types (employing air bearings) or magnetic-levitation types (employing bearings based on the Lorentz force or a reactance force). Either or both stages 554, 559 can be configured to move along a respective guide or alternatively can be guideless. See U.S. Pat. Nos. 5,623,853 and 5,528,118, incorporated herein by reference.

Further alternatively, either or both stages 554, 559 can be driven by a planar motor that drives the respective stage by electromagnetic force generated by a magnet unit having two-dimensionally arranged magnets and an armature-coil unit having two-dimensionally arranged coils in facing positions. With such a drive system, either the magnet unit or the armature-coil unit is connected to the respective stage and the other unit is mounted on a moving-plane side of the respective stage.

Movement of a stage 554, 559 as described herein can generate reaction forces that can affect the performance of the microlithography apparatus. Reaction forces generated by motion of the wafer stage 559 can be attenuated using any of the vibration-attenuation devices described above. Alternatively, the reaction forces can be shunted to the floor (ground) using a frame member as described, e.g., in U.S. Pat. No. 5,528,118, incorporated herein by reference. Reaction forces generated by motion of the reticle stage 554 can be attenuated using any of the vibration-attenuation devices described above or shunted to the floor (ground) using a frame member as described in U.S. Pat. No. 5,874,820, incorporated herein by reference.

A microlithography apparatus such as any of the various types described above can be constructed by assembling together the various subsystems, including any of the elements listed in the appended claims, in a manner ensuring that the prescribed mechanical accuracy, electrical accuracy, and optical accuracy are obtained and maintained. For example, to maintain the various accuracy specifications, before and after assembly, optical system components and assemblies are adjusted as required to achieve maximal optical accuracy. Similarly, mechanical and electrical systems are adjusted as required to achieve maximal respective accuracies. Assembling the various subsystems into a microlithography apparatus requires the making of mechanical interfaces, electrical-circuit wiring connections, and pneumatic plumbing connections as required between the various subsystems. Typically, constituent subsystems are assembled prior to assembling the subsystems into a microlithography apparatus. After assembly of the apparatus, system adjustments are made as required for achieving overall system specifications in accuracy, etc. Assembly at the subsystem and system levels desirably is performed in a clean room where temperature and humidity are controlled.

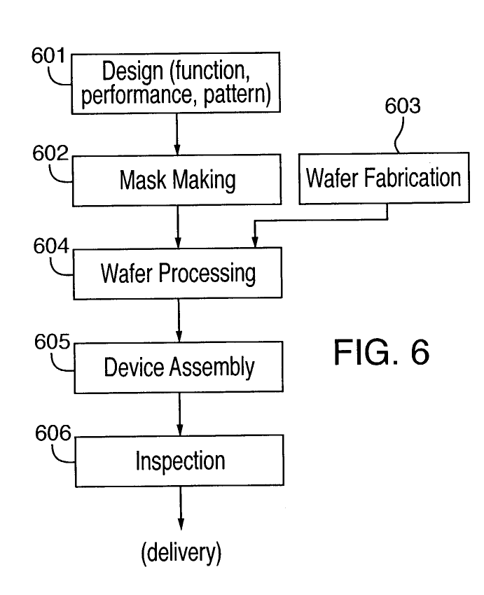

Any of various microelectronic devices (“micro-devices”) and displays can be fabricated using an apparatus as described in the representative embodiment illustrated in FIG. 5. An exemplary process is depicted in FIG. 6. In step 601, the function and performance characteristics of the subject device are designed. Next, in step 602, a mask (reticle) defining a corresponding pattern is designed according to the specifications established in the preceding step. In a parallel step 603 to step 602, a wafer or other suitable substrate is made. In step 604, the mask pattern designed in step 602 is exposed onto the wafer using a microlithography apparatus as described herein. In step 605, the microelectronic device is assembled; this typically includes dicing, bonding, and packaging steps as well known in the art. Finally, in step 606, the devices are inspected.

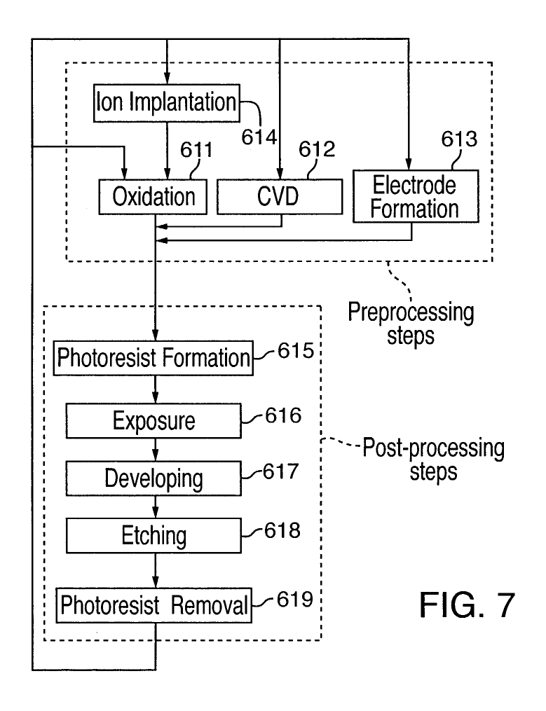

FIG. 7 is a flow chart of details of step 604, as applied to manufacturing microelectronic devices. In step 611 (oxidation), the surface of the wafer is oxidized. In step 612 (“CVD” or chemical vapor deposition), an insulating film is formed on the wafer surface. In step 613 (electrode formation), electrodes are formed on the wafer by vapor deposition. In step 614 (ion implantation), ions are implanted in the wafer. These steps 611-614 constitute the “pre-process” steps for wafers during wafer processing; during these steps selections are made as required according to processing requirements.

Continuing further with FIG. 7, at each stage of wafer processing, after the above-mentioned pre-process steps are completed, the following “post-process” steps are executed. Initially, in step 615 (photoresist formation), a layer of a suitable resist is applied to the wafer surface. Next, in step 616 (exposure), the microlithography apparatus is used to transfer the circuit pattern defined by the mask (reticle) to the wafer. In step 617 (developing), the exposed layer of resist on the wafer surface is developed. In step 618 (etching), portions of the wafer surface not protected by residual resist are removed by etching. In step 619 (photoresist removal), any resist remaining after completing the etching step is removed.

Multiple circuit patterns are formed on the wafer surface by repeating these pre-process and post-process steps as required.

Having illustrated and described several embodiments, it should be apparent to those of ordinary skill in the art that modifications, alternatives, and equivalents may be included within the spirit and scope of the invention, as defined by the appended claims.

What is claimed is:

1. A device for placement between a first mass and a second mass so as to attenuate transmission of a vibration between the masses, comprising:
a housing defining a chamber configured to be pressurized with a fluid;
at least one first pivot element pivotably coupling the housing and the first mass together and being situated in a first rotation plane; and
at least one second pivot element pivotably coupling the housing and the second mass together and being situated in a second rotation plane, wherein a lateral motion of the second mass relative to the first mass results in a rotation of the housing at the first rotation plane and the second rotation plane relative to the first and second masses, respectively.

2. The device according to claim 1, wherein the first mass and the second mass are axially aligned with each other along a support axis, the rotation of the housing in the first rotation plane occurs at a first rotation locus, the rotation of the housing in the second rotation plane occurs at a second rotation locus, and the first rotation locus and the second rotation locus are spaced apart along the support axis such that an axial distance between the first rotation locus and the first mass is less than an axial distance between the second rotation locus and the first mass, and an axial distance between the second rotation locus and the second mass is less than an axial distance between the first rotation locus and the second mass.

3. The device according to claim 1, configured such that the lateral motion of the second mass is not transmitted to the first mass.

4. The device according to claim 1, wherein the first pivot element comprises a first diaphragm, and the second pivot element comprises a second diaphragm.

5. The device according to claim 4, further comprising a first mounting element adjacent the first mass and a second mounting element adjacent the second mass, wherein the first diaphragm is mounted to the first mounting element and the second diaphragm is mounted to the second mounting element.

6. The device according to claim 4, wherein the first diaphragm is mounted to the first mass and the second diaphragm is mounted to the second mass.

7. The device according to claim 6, wherein the first diaphragm includes a perimeter affixed to a side wall of the housing, and the second diaphragm includes a perimeter affixed to the side wall of the housing.

8. The device according to claim 4, wherein the housing comprises a cylinder defining a first open end and an opposing second open end, and the first diaphragm is positioned at the first open end and the second diaphragm is positioned at the second open end.

9. The device according to claim 2, wherein the first pivot element comprises a first diaphragm, and the second pivot element comprises a second diaphragm.

10. The device according to claim 1, further comprising a first mounting element adjacent the first mass, the first mounting element defining a first surface and a second surface, and wherein the fluid in the chamber comprises a pressurized gas that contacts the first surface and the second surface so as to exert a force against the first surface and the second surface.

11. The device according to claim 10, wherein the first mounting element comprises:
a mounting plate coupled to the first mass and the first pivot element, the mounting plate defining the first surface;
a head-mounting ring coupled to a third pivot element; and
a central mounting member disposed between the mounting plate and the head-mounting ring.

12. The device according to claim 1, wherein the first mass and the second mass are axially aligned with each other along a support axis, the rotation of the housing in the first rotation plane occurs at a first rotation locus, the rotation of the housing in the second rotation plane occurs at a second rotation locus, and the first rotation locus and the second rotation locus are spaced apart along the support axis such that the first rotation locus is above the second rotation locus.

13. The device according to claim 1, further comprising a stop means for preventing movement of at least one of the first mass or the second mass greater than a predetermined tolerance distance.

14. A device for placement between a first mass and a second mass so as to attenuate transmission of a vibration between the masses, comprising:
a housing defining a chamber comprising a unitary housing wall and configured to be pressurized with a fluid;
at least one first flexible diaphragm coupled to the first mass and the unitary housing wall; and
at least one second flexible diaphragm coupled to the second mass and the unitary housing wall.

15. The device according to claim 14, wherein the first flexible diaphragm and the second flexible diaphragm further define the chamber.

16. The device according to claim 14, wherein the first diaphragm is mounted to the first mass, and the second diaphragm is mounted to the second mass.

17. The device according to claim 14, wherein:
the housing defines a first open end and a second open end;
the first diaphragm is positioned at the first open end;
the second diaphragm is positioned at the second open end;
the first mass is positioned adjacent an obverse surface of the first diaphragm; and
the second mass is positioned adjacent an obverse surface of the second diaphragm.

18. A device for placement between a first mass and a second mass so as to attenuate transmission of a vibration between the masses, comprising:
a housing defining a chamber configured to be pressurized with a fluid;
a first piston adjacent the first mass;
at least one first pivot element coupling the first piston to the housing and being situated in a first rotation plane;
a second piston adjacent the second mass; and
at least one second pivot element coupling the second piston to the housing and being situated in a second rotation plane, wherein a lateral motion of the second mass relative to the first mass results in a rotation of the housing at the first rotation plane and the second rotation plane relative to the first and second masses, respectively.

19. The device according to claim 18, wherein the first pivot element comprises a first diaphragm, and the second pivot element comprises a second diaphragm.

20. The device according to claim 18, wherein:
three first pivot elements are situated and configured to couple the first piston to housing; and
three second pivot elements are situated and configured to couple the second piston to the housing.

21. The device according to claim 18, wherein:
the first piston comprises a first piston surface and a second piston surface;
the second piston comprises a third piston surface and a fourth piston surface; and
the pressurized fluid contacts the first surface, second surface, third surface, and fourth surface such that a force is exerted against each of the first surface, second surface, third surface, and fourth surface, respectively.

22. The device according to claim 20, wherein each of the first pivot elements and second pivot elements comprises a respective diaphragm.

23. A device for placement between a first mass and a second mass so as to attenuate transmission of a vibration between the masses, comprising:
a housing defining a first chamber configured to be pressurized with a fluid;
a first mounting plate coupled to the first mass;
a first head-mounting ring;
a first central mounting member disposed between the first mounting plate and the first head-mounting ring;
a first diaphragm coupling the first mounting plate to the housing;
a second diaphragm coupling the first central mounting member to the housing;
a third diaphragm coupling the first head-mounting ring to the housing;
a second mounting plate coupled to the second mass;
a second head-mounting ring;
a second central mounting member disposed between the first mounting plate and the first head-mounting ring.
a fourth diaphragm coupling the second mounting plate to the housing;
a fifth diaphragm coupling the second central mounting member to the housing; and
a sixth diaphragm coupling the second head-mounting ring to the housing.

24. The device according to claim 23, wherein:
a first edge of the first mounting plate opposes a first surface of the first central mounting member;
a second surface of the first central mounting member opposes a first surface of the first head-mounting ring;
a first edge of the second mounting plate opposes a first surface of the second central mounting member; and
a second surface of the second central mounting member opposes a first surface of the second head-mounting ring.

25. The device according to claim 24, wherein the first chamber comprises a center section, a first distal section, and a second distal section.

26. The device according to claim 25, wherein:
the center section of the first chamber is defined by the third diaphragm, a second surface of the first head-mounting ring, the sixth diaphragm, a second surface of the second head-mounting ring, and the housing;
the first distal section of the first chamber is defined by the first diaphragm, the first mounting plate, the second diaphragm, and the housing; and
the second distal section of the first chamber is defined by the fourth diaphragm, the second mounting plate, the fifth diaphragm, and the housing.

27. The device according to claim 23, further comprising:
a second chamber defined by the housing, the second diaphragm, the third diaphragm, and the first central mounting member; and
a third chamber defined by the housing, the fifth diaphragm, the sixth diaphragm, and the second central mounting member, wherein the second chamber and the third chamber are each occupied by a gas at atmospheric pressure.

28. The device according to claim 23, wherein:
the first chamber comprises a center section, a first distal section, and a second distal section;
the first mounting plate, the first central mounting member, and the first head-mounting ring define a first passage fluidly communicating the center section of the first chamber with the first distal section of the first chamber; and
the second mounting plate, the second central mounting member, and the second head-mounting ring define a second passage fluidly communicating the center of the first chamber with the second distal section of the first chamber.

29. The device according to claim 23, wherein:
the fluid in the first chamber comprises a pressurized gas; and
the pressured gas contacts and exerts force against a surface of the first head-mounting ring, a surface of the first mounting plate, a surface of the second head-mounting ring, and a surface of the second mounting plate.

30. The device according to claim 23, wherein the housing comprises a central section disposed between a first inner section and a second inner section, a first outer section positioned adjacent the first inner section and defining a first open end, and a second outer section positioned adjacent the second inner section and defining a second open end.

31. The device according to claim 30, wherein:
a circumferential portion of the first diaphragm engages a first edge of the first outer section of the housing;
a circumferential portion of the second diaphragm is disposed between a second edge of the first outer section and a first edge of the first inner section of the housing;
a circumferential portion of the third diaphragm is disposed between a second edge of the first inner section and a first edge of the central section of the housing;
a circumferential portion of the fourth diaphragm engages a first edge of the second outer section of the housing;
a circumferential portion of the fifth diaphragm is disposed between a second edge of the second outer section and a first edge of the second inner section of the housing; and
a circumferential portion of the sixth diaphragm is disposed between a second edge of the second inner section and a second edge of the central section of the housing.

32. The device according to claim 31, wherein:
a central portion of the first diaphragm engages a first surface of the first mounting plate;
a central portion of the second diaphragm is disposed between a first edge of the first mounting plate and a first edge of the first central mounting member;
a central portion of the third diaphragm is disposed between a second surface of the first central mounting member and a first surface of the first head-mounting ring;
a central portion of the fourth diaphragm engages a first surface of the second mounting plate;
a central portion of the fifth diaphragm is disposed between a first edge of the second mounting plate and a first surface of the second central mounting member; and
a central portion of the sixth diaphragm is disposed between a second surface of the second central mounting member and a first surface of the second head-mounting ring.

33. A device for placement between a first mass and a second mass so as to attenuate transmission of a vibration between the masses, comprising:
a housing defining a chamber configured to be pressurized with a fluid;
at least one first pivot element pivotably coupling the housing and the first mass together; and
at least one second pivot element pivotably coupling the housing and the second mass together,
wherein the first pivot element and the second pivot element are arranged in an inverted pendulum configuration relative to each other.

34. The device according to claim 33, wherein a lateral motion of the second mass relative to the first mass results in a rotation of the housing relative to the first and second masses, respectively

35. A system for attenuating vibration transmission from a first mass to a second mass, comprising:
a first vibration-attenuation device coupled to the first mass and the second mass, wherein the first vibration-attenuation device comprises a housing coupled to the second mass, a cylinder received within the housing, a mounting element coupled to the first mass, a first diaphragm coupled to the housing and the cylinder, and a second diaphragm coupled to the mounting element and the cylinder; and
a second vibration-attenuation device as recited in claim 1, situated parallel to the first vibration-alteration device between the first and second masses.

36. A system for attenuating vibration transmission from a first mass to a second mass, comprising:
a first vibration-attenuation device coupled to the first mass and the second mass, wherein the first vibration-attenuation device comprises a housing coupled to the second mass, a cylinder received within the housing, a mounting element coupled to the first mass, a first diaphragm coupled to the housing and the cylinder, and a second diaphragm coupled to the mounting element and the cylinder; and
a second vibration-attenuation device as recited in claim situated parallel to the first vibration-alteration device between the first and second masses.

37. A lithographic exposure device, comprising a device as recited in claim 1.

38. A lithographic exposure device, comprising a device as recited in claim 23.

39. A lithographic exposure device, comprising a system as recited in claim 35.

40. A lithographic exposure device, comprising a device as recited in claim 36.

41. A micro-device manufactured using the lithographic exposure device of claim 37.

42. A micro-device manufactured using the lithographic exposure device of claim 38.

43. A micro-device manufactured using the lithographic exposure device of claim 39.

44. A micro-device manufactured using the lithographic exposure device of claim 40.
